(19) United States
(12) Patent Application Publication
(10) Pub. No.: US 2026/0222938 A1
(43) Pub. Date: Jul. 30, 2026

(54) RFCOMM CONNECTION HANDOVER BETWEEN TWO DIFFERENT STACKS

(71) Applicant: QUALCOMM Incorporated, San Diego, CA (US)

(72) Inventors: Anubhav GUPTA, Hyderabad (IN); Yanhui GUO, Shanghai (CN); Yusheng YANG, Shanghai (CN); Tony GOGOI, San Diego, CA (US)

(21) Appl. No.: 19/142,156

(22) PCT Filed: Feb. 16, 2023
(86) PCT No.: PCT/CN2023/076373

§ 371 Date: Jun. 20, 2025

(51) Int. Cl. H04W 36/00

(52) U.S. Cl. CPC H04W 36/035; H04W 36/0033

(57) ABSTRACT

Various embodiments include methods for computing devices managing a radio frequency communication (RFCOMM) connection handover between a first Bluetooth (BT) stack and a second BT stack. Embodiments may include establishing an Asynchronous Connection-oriented Logical transport connection with a BT device and transmitting a synchronization message including BT context information from the first BT stack to the second BT stack. Methods may further include establishing an RFCOMM session between the computing device and the BT device, receiving, by the first BT stack, a Set Asynchronous Balanced Mode (SABM) command from the BT device, transmitting the SABM command to the second BT stack, transmitting a filter policy based on the SABM command from the second BT stack to a BT controller of the computing device, transmitting, from the second BT stack, a ready message when the BT controller has been configured and an Unnumbered Acknowledgement (UA) message to the BT device.

### BACKGROUND

User equipment (UE) and consumer devices for communicating data via Bluetooth (BT)/Bluetooth Low Energy (BLE) have become increasingly complex, especially in devices implementing active mode and low power mode features. In an active mode, an application processor may manage BLE connections and operations of high-performance BT applications. To conserve battery life, a device may transition from the active mode to a low power mode during times in which the high-performance BT applications are not operating or have minimal functionality and processes that may be sufficiently handled by a separate low power processor. In the low power mode, a second processor with limited functionality may manage the baseline operations of the high-performance applications. The low power processor may also wholly manage BT applications that require minimal processing power, therefore eliminating the need to supply operational power to an application processor. Transitioning between an active mode and a low power mode may require significant oversight and computational resources to ensure that BLE context information and other BT data related to the ongoing operations of both BT and BLE applications is not lost, out of synchronization, or redirected to an incorrect BT stack.

### SUMMARY

Various aspects include methods that may be performed by a computing device for managing a radio frequency communication (RFCOMM) connection handover between a first Bluetooth (BT) stack and a second BT stack. Various aspects may include receiving a connection request message from a BT device, establishing an Asynchronous Connection-oriented Logical transport (ACL) connection between the computing device and the BT device in response to the connection request message, and transmitting a synchronization message including BT context information from the first BT stack to the second BT stack. In some aspects, the BT context information may include at least one of a BT device address (BD_ADDR), a link key, or a connection handle.

Some aspects may further include receiving, by the first BT stack, a service discovery protocol (SDP) search request message from the BT device, and transmitting, from the first BT stack, an SDP response message to the BT device in response to the SDP request message.

Some aspects may further include instantiating the first BT stack and the second BT stack at bootup of the computing device, receiving, by the first BT stack, a secondary SDP database from the second BT stack, and storing a primary SDP database of the first BT stack in conjunction with the secondary SDP database.

Some aspects may further include receiving, by the first BT stack, a secondary SDP database from the second BT stack in response to transitioning from a low power mode to an active mode of the computing device, and storing a primary SDP database of the first BT stack in conjunction with the secondary SDP database.

Some aspects may further include establishing an RFCOMM session between the computing device and the BT device, receiving, by the first BT stack, a Set Asynchronous Balanced Mode (SABM) command from the BT device, transmitting the SABM command from the first BT stack to the second BT stack, transmitting a filter policy from the second BT stack to a BT controller of the computing device, wherein the filter policy is based on the SABM command, transmitting, from the second BT stack to the first BT stack, a ready message indicating that the BT controller has been configured with the filter policy, and transmitting an Unnumbered Acknowledgement (UA) message from the first BT stack to the BT device. Some aspects may further include receiving, by the BT controller, Unnumbered Information with Header check (UIH) frames including a Parameter Negotiation (PN) command from the BT device, determining, by the BT controller, a destination stack of the PN command based on the filter policy, wherein the destination stack is the first BT stack or the second BT stack, transmitting the PN command from the BT controller to the destination stack, and transmitting a PN response from the destination stack to the BT device in response to the PN command.

Some aspects may further include establishing an RFCOMM session between the computing device and the BT device, receiving, by the first BT stack, a SABM) command from the BT device, transmitting an UA message from the first BT stack to the BT device, receiving, by the first BT stack, UIH frames including a PN command from the BT device, determining whether a Data Link Connection Identifier (DLCI) channel is implemented by an application processor implementing the first BT stack or by a low power processor implementing the second BT stack, and implementing one of: transmitting, from the first BT stack to the BT device, a UIH response message including nonzero credits in response to determining that the DLCI channel is implemented by the application processor; or transmitting, from the first BT stack to the BT device, a UA response message including zero credit in response to determining that the DLCI channel is implemented by the low power processor. receiving, by the first BT stack, a subsequent SABM command from the BT device, transmitting the subsequent SABM command from the first BT stack to the second BT stack, transmitting a filter policy from the second BT stack to a BT controller of the computing device, wherein the filter policy is based on the subsequent SABM command, transmitting a subsequent UA message from the second BT stack to the BT device, and transmitting, from the second BT stack, a subsequent UIH message including nonzero credits to the BT device.

Further aspects may include a computing device having a processor configured to perform operations of any of the methods summarized above. Further aspects may include a computing device having means for performing functions of any of the methods summarized above. Further aspects may include a non-transitory processor-readable medium having stored thereon processor-executable instructions configured to cause a processor of a computing device to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a system block diagram illustrating an example communication system suitable for implementing any of the various embodiments.

FIG. 2 is a component block diagram illustrating an example computing device suitable for implementing any of the various embodiments.

FIG. 3 is a component block diagram illustrating an example system managing Radio Frequency Communication (RFCOMM) connection handover between two different stacks according to some embodiments.

FIG. 4 is a component block diagram illustrating an example Bluetooth (BT)/Bluetooth Low Energy (BLE) system architecture according to some embodiments.

FIGS. 5A-5C are message flow diagrams illustrating operations for managing an RFCOMM connection handover between two different BT stacks according to some embodiments.

FIG. 6A is a process flow diagram of an example method that may be performed by a computing device for managing RFCOMM connection handover between two different stacks in accordance with various embodiments.

FIGS. 6B-6H are process flow diagrams of example operations that may be performed as part of the method illustrated in FIG. 6A as described for managing RFCOMM connection handover between two different stacks in accordance with some embodiments.

FIG. 7 is a component block diagram illustrating an example computing device suitable for use with the various embodiments.

FIG. 8 is a component block diagram illustrating an example wireless communication device suitable for use with the various embodiments.

FIG. 9 illustrates an example wearable computing device in the form of a smart watch according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments described herein include Bluetooth (BT) devices and methods and BT processors that facilitate Radio Frequency Communication (RFCOMM) connection transitions between a BT stack of an application processor and a BT stack of a low power processor. Various embodiments include operations to synchronize Service Discovery Protocol (SDP) information during concurrent operation of the low power processor and the application processor (i.e., during a transition between an active mode and a low power mode, and vice versa).

The term “system-on-a-chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SoCs may also include software for controlling the integrated resources and processors, as well as for controlling peripheral devices.

The term “system-in-a-package” (SIP) may be used herein to refer to a single module or package that contains multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high-speed communication circuitry and packaged in close proximity, such as on a single motherboard or in a single computing device. The proximity of the SoCs facilitates high speed communications and the sharing of memory and resources.

The term “BT data” may be used herein to refer to any data received or transmitted across a BT/Bluetooth Low Energy (BLE) connection and any information associated with conveying data across said BT/BLE connection. Specifically, BT data may refer to any data (e.g., data packets) received or transmitted across a BT or BLE connection to an endpoint (e.g., BT/BLE application). BT data may also refer to any information used to establish and maintain BT/BLE connections and to communicate data packets through various layers of a BT/BLE stack (e.g., BT controller, Host, applications) of a processor (e.g., low power processor, high-performance, or application, processor), such as packet header information, system information blocks (SIBs), system integrity information such as number of completed packets (NoCP), service discovery protocol (SDP) information, packet identifiers, attribute handles, connection handles, and channel identifiers associated with BT data packets.

An increased number of wireless-capable devices are being developed that require or support high-performance operations. As a result of implementing increasingly complex processors, power consumption within these devices has increased. Increased power consumption is especially problematic in smaller devices, such as wearable devices that are battery-powered, including smart watches, virtual reality (VR) goggles, smart glasses, and medical devices that typically utilize small-profile rechargeable batteries due to physical design constraints. Such devices often utilize BT and/or BT Low Energy (BLE) to convey information with another paired device. Advertising and scanning for devices, and establishing and maintaining a BT/BLE connection may further increase power consumption within a given device.

To accommodate this increase in power demand, wearable devices are being designed with two processors, an application, or high-performance, processor for managing operations of high-performance BT applications during an active, or high-performance, mode, and a low power BT processor for managing low power BT applications and also baseline device operations during a low power mode when the high-performance BT applications are not requiring an advanced level of processing power.

Typically, in low power mode, the application processor is turned off or in a sleep mode, and the low power processor takes over control of device operations. When a BT/BLE application requires an advanced degree and/or amount of processing, the application processor may activate or wake up, and enter the active mode. Such devices frequently transition processing of BT/BLE applications from the low power processor back to the application processor and vice versa in order to minimize power consumption.

Transitioning between the active mode and the low power mode requires sharing and transferring of BT context information between a BT protocol stack of the application processor and a BT protocol stack of the low power processor. Synchronized and/or shared BT context information between the application processor and the low power processor is required to maintain existing BT/BLE connections and to maintain lossless data transfer throughout those BT/BLE connections. This synchronization may require computational processes and resources, which may increase the transition time between active mode and low power mode. For example, a BT stack of an application processor may receive an SDP request from a paired BT device, but may have to perform multiple operations to fetch the SDP information from a BT stack of the low power processor. Consequently, the application processor may spend more time in the active mode than necessary for meeting device processing demands, and therefore may not maximize conservation of battery power.

More specifically, various RFCOMM services within a computing device (i.e., RFCOMM services on both the application processor and the low power processor) will employ different service channels, each channel represented by a Data Link Connection Identifier (DLCI) number (e.g., DLCI0, DLCI1, etc.). Whenever the computing device receives an SDP request from a paired, external BT device (i.e., peer), the computing device should respond with a complete SDP record containing the RFCOMM channel number for both the low power processor and the application processor. Some Multiplexer Control commands pertaining to specific DLCIs may be exchanged on the control channel (DLCI0) before the corresponding DLCI can been established. Creation of DLCI0 channel must be handled by primary stack. Receive filters on a BT controller within the computing device should be registered between Logical Link Control and Adaptation Layer Protocol (L2CAP) (i.e., RFCOMM protocol service multiplexor) creation and receiving BT data on RFCOMM.

Various embodiments include methods and BT processors of a BT-equipped computing device for managing RFCOMM connection handover between two different BT stacks (i.e., BT stack of an application processor and a BT stack of a low power processor). Various embodiments address the aforementioned issues for handing over RFCOMM connections between concurrently operating BT stacks. For example, various embodiments include an application processor BT stack that manages Asynchronous Connection-oriented Logical transport (ACL) connections. After configuring or otherwise establishing an ACL connection between the application processor BT stack and a paired BT device, the application processor BT stack may synchronize BT context information (e.g., BT device address, link key, connection handle) with the low power processor BT stack. In some embodiments, the low power processor BT stack may register its SDP database to the application processor BT stack at bootup and/or whenever a new RFCOMM channel is added. Thus, the application processor BT stack may retain or otherwise manage an SDP database containing SDP records for both the application processor and the low power processor. A complete SDP database may allow the application processor BT stack to instantly respond to SDP request from a paired BT device without having to fetch SDP information from the low power processor BT stack, therefore reducing the number of processes to respond to an SDP request. Fewer processor to respond to an SDP request may reduce the time it takes to transition between active and low power modes, increasing battery longevity of the computing device.

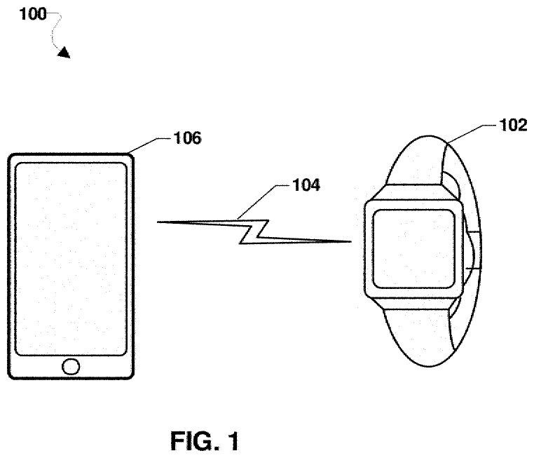

FIG. 1 is a system block diagram illustrating an example communication system suitable for implementing any of the various embodiments. The communication system 100 may be a short-range communications network including multiple devices capable of wireless communication. For example, the communication system 100 may be a BT/BLE communication system including a first BT device 102 and second BT device 106.

The first BT device 102 may be any type of computing device capable of BT/BLE communications, such as a wearable device (e.g., smart watch, smart glasses, virtual reality systems, and medical devices such as heart monitors). The second BT device 106 may be any type of computing device capable of BT/BLE communications that is communicatively compatible with the first BT device 102. The first BT device 102 may be communicatively coupled to the second BT device 106 via wireless connection 104, which may be a BT/BLE wireless connection. For ease of illustration, the communication system 100 includes one communicatively connected, or paired, BT device 106. However, more paired BT device 106 may be implemented within the communications system 100. For example, the first BT device 102 may be paired with multiple BT devices simultaneously including the second BT device 106 and additional BT devices of a same or different type (e.g., cellular phone, laptop computer, multimedia displays, other wearable device such as audio output devices, Point-of-Sale systems) that are capable of BT/BLE communications.

The wireless connection 104 may be a BT/BLE connection established via handshaking processes between the first BT device 102 and the second BT device 106. The first BT device 102 may query or otherwise determine a preferred connection type, such as a codec type, of each discoverable BT device within communications range, including the second BT device 106, and may establish each a wireless connection 104 according to each preferred connection type. For example, the wireless connection 104 may be established based at least on a preferred codec type implemented by the second BT device 106.

The first BT device 102 may transmit BT data to and receive BT data from the second BT device 106 according to the specific protocols and connection type of the wireless connection 104. For example, the first BT device 102 may encode BT data (e.g., audio data) to be transmitted to the second BT device 106 via the wireless connection 104, and transmit the encoded BT data to the second BT device 106 via the wireless connection 104. After receiving the encoded BT data, the second BT device 106 may decode the encoded BT data for use in various BT/BLE applications or applications that may utilize BT data. Similarly, the second BT device 106 may encode BT data and transmit the encoded BT data to the first BT device 102 via the wireless connection 104. After receiving the encoded BT data, the first BT device 102 may decode the encoded BT data for use in various BLE applications or applications that may utilize BT data. BT data may include data such as context information for both classic BT (i.e., BR/EDR data) and BLE operations. For example, BT data may refer to BR/EDR context information during an active mode of operation, and BT data may also refer to BLE context information during a low power mode of operation.

The first BT device 102 may function in various BT/BLE modes as defined by Bluetooth Core Specification v5.3. For example, the first BT device 102 may function and perform operations in an active mode (i.e., high-performance mode) or a low power mode (i.e., sleep mode, low-performance mode). The first BT device 102 may include two or more processors, which may be utilized depending on the mode of operation. For example, the first BT device 102 may include a low power processor that may perform BLE functions during a low power mode, and an application processor (i.e., performance processor) that may perform functions alongside the low power processor during an active mode. Thus, the first BT device 102 may conserve battery life by when in a low power mode by utilizing only the low power processor, and may perform BT operations when in an active mode by utilizing the application processor.

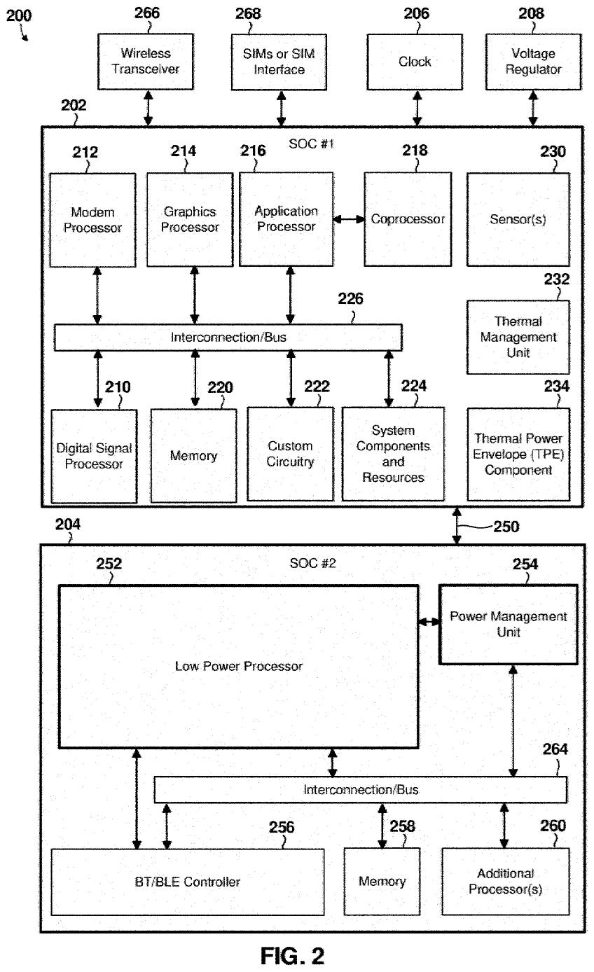

FIG. 2 is a component block diagram illustrating an example computing device 200 suitable for implementing any of the various embodiments. Various embodiments may be implemented on a number of single processor and multiprocessor computer systems, including a system-on-chip (SoC) or system in a package. The computing device 200 may be implemented as a wearable device or BT/BLE-capable device (e.g., first BT device 102, second BT device 106).

With reference to FIGS. 1-2, the illustrated example computing device 200 (which may be a system-in-a-package in some embodiments) includes a two SoCs 202, 204 coupled to a clock 206, a voltage regulator 208, at least one subscriber identity module (SIM) 268 and/or a SIM interface and a wireless transceiver 266 configured to send and receive wireless communications via an antenna (not shown) to/from wireless computing devices, such as a base station and/or BLE-capable wireless device (e.g., second BT device 106). In some embodiments, the first SoC 202 may operate as central processing unit (CPU) of the computing device 200 that carries out the instructions of software application programs by performing the arithmetic, logical, control and input/output (I/O) operations specified by the instructions. In some embodiments, the second SoC 204 may operate as a specialized processing unit. For example, the second SoC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SoC 202 may include a digital signal processor (DSP) 210, a modem processor 212, a graphics processor 214, an application processor (AP) 216, one or more coprocessors 218 (e.g., vector co-processor) connected to one or more of the processors, memory 220, custom circuity 222, system components and resources 224, an interconnection/bus module 226, one or more sensors 230 (e.g., accelerometer, temperature sensor, pressure sensor, optical sensor, infrared sensor, analog sound sensor, etc.), a thermal management unit 232, and a thermal power envelope (TPE) component 234. The second SoC 204 may include a low power processor 252, a power management unit 254, an interconnection/bus module 264, a BT/BLE controller 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SoC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SoC 202, 204 may include various system components, resources, and custom circuitry for managing sensor data, analog-to-digital conversions, wireless data transmissions, and for performing other specialized operations, such as decoding data packets and processing encoded audio and video signals for rendering in a web browser or audio/video application. For example, the system components and resources 224 of the first SoC 202 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 224 and/or custom circuitry 222 may also include circuitry to interface with peripheral devices, such as cameras, electronic displays, wireless communication devices, external memory chips, etc.

The first and second SoC 202, 204 may communicate via interconnection module 250. In some embodiments, the interconnection module may be a connection established by transceiving (i.e., receiving and transmitting) components within both the SoC 202 and SoC 204. In some embodiments, the interconnection module 250 may include a serial peripheral interface (SPI), which is an interface that enables the serial (one bit at a time) exchange of data between two devices operating in full duplex mode. In some embodiments, the interconnection module 250 may be of a bus architecture. In some embodiments, the low power processor 252 may include a universal asynchronous receiver-transmitter (UART) and the application processor 216 may include a multiple signal messages (MSM) UART driver that is communicatively connected to the UART of the low power processor 252.

The various processors 210, 212, 214, 216, 218, may be interconnected to one or more memory elements 220, system components and resources 224, and custom circuitry 222, and a thermal management unit 232 via an interconnection/bus module 226. Similarly, the low power processor 252 may be interconnected to the power management unit 254, the BT/BLE controller 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SoCs 202, 204 may further include an input/output module (not illustrated) for communicating with resources external to the SoC, such as a clock 206, a voltage regulator 208, one or more wireless transceivers 266, and at least one SIM 268 and/or SIM interface (i.e., an interface for receiving one or more SIM cards). Resources external to the SoC (e.g., clock 206, voltage regulator 208) may be shared by two or more of the internal SoC processors/cores. The at least one SIM 268 (or one or more SIM cards coupled to one or more SIM interfaces) may store information supporting multiple subscriptions, including a first 5GNR subscription and a second 5GNR subscription, etc.

In addition to the example computing device 200 discussed above, various embodiments may be implemented in a wide variety of computing systems, which may include a single processor, multiple processors, multicore processors, or any combination thereof.

In some embodiments, the various processors of the SoC 202 and SoC 204 may be located within a same SoC. For example, the application processor 216 and low power processor 252 may be located within a same SoC, such as in a single SoC of a wearable device, to perform BT/BLE functions in both a low power mode (i.e., low power processor 252 is utilized) and an active mode (i.e., application processor is activated and utilized). As another example, a computing device, such as a wearable device (e.g., first BT device 102), may include the SoC 102 to perform BT/BLE functions in both a low power mode and an active mode, in which the low power processor 252 is utilized during a low power mode, and an application processor of the additional processors 260 is activated and utilized during an active mode.

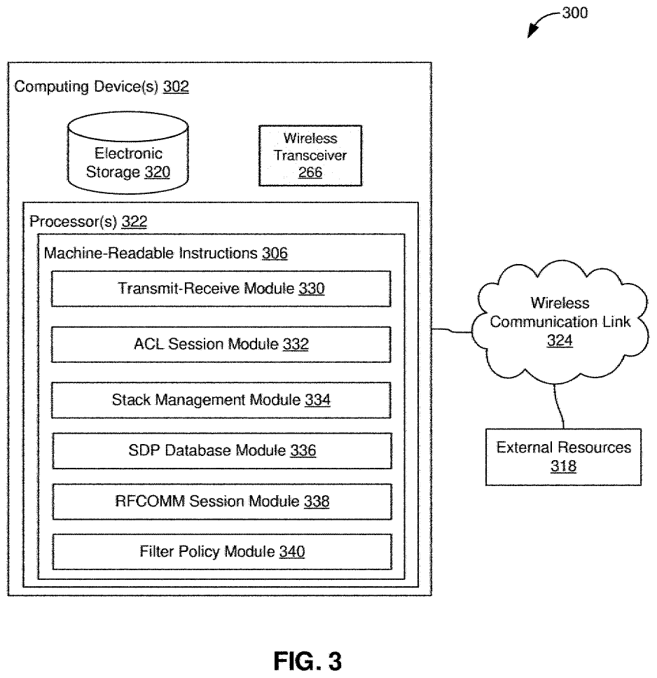

FIG. 3 is a component block diagram illustrating an example system 300 for managing RFCOMM connection handover between two different stacks according to some embodiments. With reference to FIGS. 1-3, the system 300 may include one or more computing device(s) 302 (e.g., the first BT device 102, computing device 200) and external resources 318, which may communicate via a wireless communication link 324 (e.g., wireless connection 104). External resources 318 may include sources of information outside of the system 300, external entities participating with the system 300, or other resources. For example, external resources 318 may be a paired BT device such as the second BT device 106. In some implementations, some or all of the functionality attributed herein to external resources 318 may be provided by resources included in the system 300. The system 300 may include a plurality of hardware, software, and/or firmware components operating together to provide the functionality attributed herein to the processor 322.

The computing device(s) 302 may include electronic storage 320 that may be configured to store information related to functions implemented by a transmit-receive module 330, an Asynchronous Connection-oriented Logical transport (ACL) session module 332, a stack management module 334, an SDP database module 336, an RFCOMM session module 338, a filter policy module 340, and any other instruction modules.

The electronic storage 320 may include non-transitory storage media that electronically stores information. The electronic storage 320 may include one or both of system storage that is provided integrally (i.e., substantially non-removable) with the system 200 and/or removable storage that is removably connectable to the system 200 via, for example, a port (e.g., a universal serial bus (USB) port, a firewire port, etc.) or a drive (e.g., a disk drive, etc.).

In various embodiments, electronic storage 320 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. The electronic storage 320 may include one or more virtual storage resources (e.g., cloud storage, a virtual private network, and/or other virtual storage resources). The electronic storage 320 may store software algorithms, information determined by processor(s) 322, and/or other information that enables the system 300 to function as described herein.

The computing device(s) 302 may be configured by machine-readable instructions 306. Machine-readable instructions 306 may include one or more instruction modules. The instruction modules may include computer program modules. The instruction modules may include one or more of the transmit-receive module 330, the ACL session module 332, the stack management module 334, the SDP database module 336, the RFCOMM session module 338, the filter policy module 340, and other instruction modules (not illustrated). The computing device(s) 302 may include processor(s) 322 configured to implement the machine-readable instructions 306 and corresponding modules.

The processor(s) 322 may include one of more local processors that may be configured to provide information processing capabilities in the system 300. As such, the processor(s) 322 may include one or more of a digital processor, an analog processor, a digital circuit designed to process information, an analog circuit designed to process information, a state machine, and/or other mechanisms for electronically processing information. Although the processor(s) 322 is shown in FIG. 3 as a single entity, this is for illustrative purposes only. In some embodiments, the processor(s) 322 may include a plurality of processing units. These processing units may be physically located within the same device, or the processor(s) 322 may represent processing functionality of a plurality of devices distributed in the system 300.

In some embodiments, the processor(s) 322 executing the transmit-receive module 330 may be configured to receive a connection request message from a BT device. In some embodiments, the processor(s) 322 executing the transmit-receive module 330 may be configured to transmit a synchronization message including BT context information from the first BT stack to the second BT stack. In some embodiments, the processor(s) 322 executing the transmit-receive module 330 may be configured to receive, by the first BT stack, an SDP search request message from the BT device. In some embodiments, the processor(s) 322 executing the transmit-receive module 330 may be configured to transmit, from the first BT stack, an SDP response message to the BT device in response to the SDP request message. In some embodiments, the processor(s) 322 executing the transmit-receive module 330 may be configured to receive, by the first BT stack, an SDP database from the second BT stack. In some embodiments, the processor(s) 322 executing the transmit-receive module 330 may be configured to receive, by the first BT stack, an SDP database from the second BT stack in response to transitioning from a low power mode to an active mode of the computing device. In some embodiments, the processor(s) 322 executing the transmit-receive module 330 may be configured to receive, by the first BT stack, a Set Asynchronous Balanced Mode (SABM) command from the BT device. In some embodiments, the processor(s) 322 executing the transmit-receive module 330 may be configured to transmit the SABM command from the first BT stack to the second BT stack. In some embodiments, the processor(s) 322 executing the transmit-receive module 330 may be configured to transmit a filter policy from the second BT stack to a BT controller of the computing device, in which the filter policy is based on the SABM command. In some embodiments, the processor(s) 322 executing the transmit-receive module 330 may be configured to transmit, from the second BT stack to the first BT stack, a ready message indicating that the BT controller has been configured with the filter policy. In some embodiments, the processor(s) 322 executing the transmit-receive module 330 may be configured to transmit an Unnumbered Acknowledgement (UA) message from the first BT stack to the BT device. In some embodiments, the processor(s) 322 executing the transmit-receive module 330 may be configured to receive, by the BT controller, Unnumbered Information with Header check (UIH) frames including a Parameter Negotiation (PN) command from the BT device. In some embodiments, the processor(s) 322 executing the transmit-receive module 330 may be configured to transmit the PN command from the BT controller to the destination stack. In some embodiments, the processor(s) 322 executing the transmit-receive module 330 may be configured to transmit a PN response from the destination stack to the BT device in response to the PN command. In some embodiments, the processor(s) 322 executing the transmit-receive module 330 may be configured to transmit a UA message from the first BT stack to the BT device. In some embodiments, the processor(s) 322 executing the transmit-receive module 330 may be configured to receive, by the first BT stack, UIH frames including a PN command from the BT device. In some embodiments, the processor(s) 322 executing the transmit-receive module 330 may be configured to transmit, from the first BT stack to the BT device, a UIH response message including nonzero credits in response to determining that the Data Link Connection Identifier (DLCI) channel is implemented by the application processor. In some embodiments, the processor(s) 322 executing the transmit-receive module 330 may be configured to transmit, from the first BT stack to the BT device, a UA response message including zero credit in response to determining that the DLCI channel is implemented by the low power processor. In some embodiments, the processor(s) 322 executing the transmit-receive module 330 may be configured to receive, by the first BT stack, a subsequent SABM command from the BT device. In some embodiments, the processor(s) 322 executing the transmit-receive module 330 may be configured to transmit the subsequent SABM command from the first BT stack to the second BT stack. In some embodiments, the processor(s) 322 executing the transmit-receive module 330 may be configured to transmit a filter policy from the second BT stack to a BT controller of the computing device, wherein the filter policy is based on the SABM command. In some embodiments, the processor(s) 322 executing the transmit-receive module 330 may be configured to transmit a subsequent UA message from the second BT stack to the BT device. In some embodiments, the processor(s) 322 executing the transmit-receive module 330 may be configured to transmit, from the second BT stack, a subsequent UIH message including nonzero credits to the BT device.

In some embodiments, the processor(s) 322 executing the ACL session module 332 may be configured to establish an ACL connection between the computing device and the BT device in response to the connection request message.

In some embodiments, the processor(s) 322 executing the stack management module 334 may be configured to instantiate the first BT stack and the second BT stack at bootup of the computing device. In some embodiments, the processor(s) 322 executing the stack management module 334 may be configured to determine whether a DLCI channel is implemented by an application processor implementing the first BT stack or by a low power processor implementing the second BT stack.

In some embodiments, the processor(s) 322 executing the SDP database module 336 may be configured to store a primary SDP database of the first BT stack in conjunction with the secondary SDP database.

In some embodiments, the processor(s) 322 executing the RFCOMM session module 338 may be configured to establish an RFCOMM session between the computing device and the BT device.

In some embodiments, the processor(s) 322 executing the filter policy module 340 may be configured to determine, by the BT controller, a destination stack of the PN command based on the filter policy, in which the destination stack is the first BT stack or the second BT stack.

The processor(s) 322 may execute the modules 330-340 and/or other modules by software, hardware, firmware, some combination of software, hardware, and/or firmware, and/or other mechanisms for configuring processing capabilities on processor(s) 322.

The description of the functionality provided by the different modules 330-340 is for illustrative purposes, and is not intended to be limiting, as any of modules 330-340 may provide more or less functionality than is described. For example, one or more of modules 330-340 may be eliminated, and some or all of its functionality may be provided by other ones of modules 330-340. As another example, processor(s) 322 may execute one or more additional modules that may perform some or all of the functionality attributed below to one of modules 330-340.

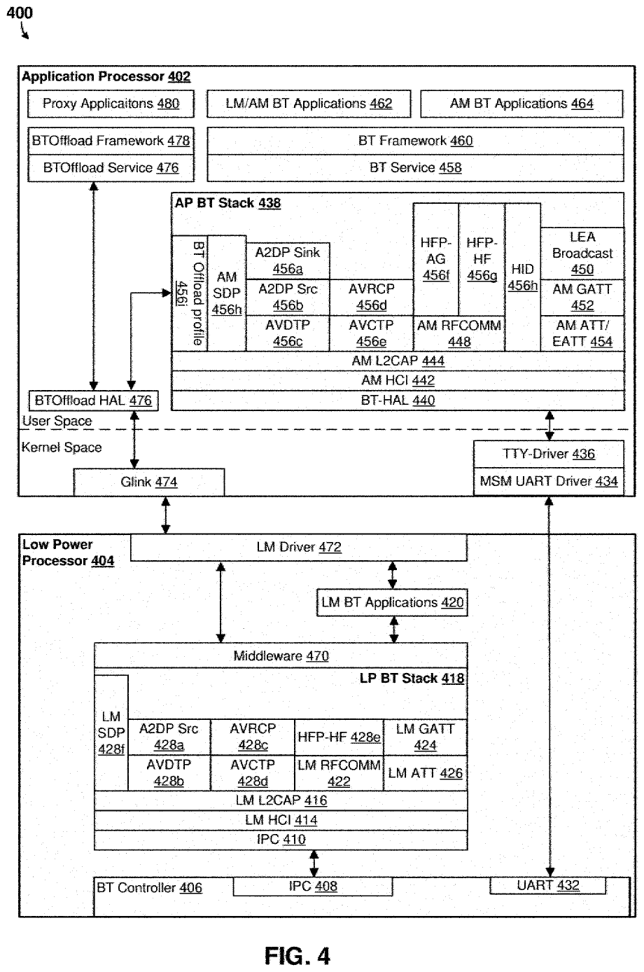

FIG. 4 is a component block diagram illustrating an example BT/BLE system architecture 400 including a stack configuration according to some embodiments. With reference to FIGS. 1-4, the BT/BLE system architecture 400 may be implemented on an application processor 402 (e.g., application processor 216, application processor of additional processors 260) and a low power processor (e.g., low power processor 252) of a BT device (e.g., first BT device 102, computing device 200, 302). The application processor 402 may be activated, or otherwise powered on or awoken, to perform BT-related operations during a BT active mode. During a BLE low power mode, sleep mode, or periods of inactivity (e.g., when BT data transfer has not happened for a configurable amount of time), the application processor 402 may be deactivated, powered off, or enter a sleep (low power) state, and the low power processor 404 may perform BT/BLE-related operations.

The application processor 402 may include an active mode AP BT stack 438 (e.g., Fluoride, BlueZ, FreeBSD, Mac OS X, Microsoft BT stack, BlueCode+, etc.) that supports operations of low power mode (LM)/AM BT applications 462 that may be executed in both an LM and AM. The application processor may further support operations of AM BT applications 464 and proxy applications 480 that may be executed in an AM. The low power processor 404 may include an LP BT stack 418 that supports operations of LM BT applications 420 that run solely during a LM. The application processor 402 may include BT Service 458 and BT Framework 460 to support LM/AM BT applications 462 and AM BT applications 464, and may further include BTOffload Service 576 and BTOffload Framework 478 to support the proxy applications 480. The BT framework 460 and BTOffload Framework 478 may be application code that may utilize BT application programming interfaces (APIs) to interact with BT hardware. The BT Service 458 may interface the BT Framework 460 with the AP BT stack 438, and the BTOffload Service 476 may interface the BTOffload Framework 478 with the AP BT stack 438.

The low power processor 404 may include a BT controller 406 for interfacing and communicating with one or more paired BT devices (e.g., second BT device 106). The BT controller 406 may include a communication interface, such as an inter-process communication (IPC) module 408 and a universal asynchronous receiver-transmitter (UART) 432. The IPC module 408 may be configured to receive BT data (e.g., BT context information) from another BT device (e.g., second BT device 106) during an LM of the BT/BLE system architecture 400. The UART 432 may be configured to receive BT data (e.g., BT context information) from another BT device (e.g., second BT device 106) during an AM of the BT/BLE system architecture 400. The LP BT stack 418 may include an IPC 410 for communicating BT data with the IPC module 408 of the BT controller 406 during either a LM. The LP BT stack 418 may include an IPC 410 for communicating BT data with the IPC module 408 of the BT controller 406 during a LM.

The LP BT stack 418 may include any number of known BT profiles 428 or specifications that may define how BT data is transferred from one device (e.g., first BT device 102, system architecture 400) to another connected device (e.g., second BT device 106). The BT profiles 428 within the LP BT stack 418 may include, but are not limited to, profiles usable in LM, such as Advanced Audio Distribution Profile Source (A2DP Src) 428a, Audio/Video Distribution Transport Profile (AVDTP) 428b, Audio/Video Remote Control Profile (AVRCP) 428c, Audio/Video Control Transport Profile (AVCTP) 428d, Hands-Free Profile Hands-Free unit (HFP-HF) 428e, and LM Service Discovery Protocol (SDP) 428f. The LP BT stack 418 may further include an LM ATTribute (ATT) 426 protocol, an LM General ATT (GATT) 424, an LM RFCOMM (Radio frequency communication) 422, an LM Logical Link Control and Adaptation Layer Protocol (L2CAP) 416, and an LM Host Controller Interface (HCl) 414. The LM GATT 424 and LM L2CAP 416 may configure a wireless connection via the LM HCl 414 using one of the BT profiles 428. The LM RFCOMM 422 is a set of transport protocols made on top of the LM L2CAP 416 providing emulated RS-232 serial ports. The LM GATT 424 may define the way in which two BT devices (e.g., first BT device 102, second BT device 106) transfer BT data back and forth using Profiles (e.g., BT Profiles 428), Services, and Characteristics during a low power mode. The LM GATT 424 may utilize LM ATT 426 to store Profiles, Services, Characteristics, and other BT context information related to the functions and operation of the LM BT applications 420 during a low power mode of the system architecture 400. In other words, the LM GATT 424 may configure how BT data is transferred across the wireless connection based on the LM ATT 426.

The AP BT stack 438 may include any number of known BT profiles 456 or specifications that may define how BT data is transferred from one device (e.g., first BT device 102, system architecture 400) to another connected device (e.g., second BT device 106). The BT profiles 456 within the AP BT stack 438 may include, but are not limited to, profiles usable in both LM and AM, such as A2DP Src 456b, AVDTP 456c, AVRCP 456d, AVCTP 456e, HFP-HF 456g, and AM SDP 456h, and profiles usable in active mode only such as A2DP Sink 456a, Hands-Free Profile Audio Gateway (HFP-AG) 456f, Human Interface Device profile (HID) 456h, and BT Offload profile 456i.

The AP BT stack 438 may further include an AM ATT/enhanced ATT (EATT) 454 protocol, an AM GATT 452, an AM RFCOMM 448, an AM L2CAP 444, and an AM HCl 442. The AM GATT 452 and AM L2CAP 444 may configure a wireless connection via the AM HCl 442 using one of the BT profiles 456. The AM RFCOMM 448 is a set of transport protocols made on top of the AM L2CAP 444 providing emulated RS-232 serial ports. The AM GATT 452 may define the way in which two BT devices (e.g., first BT device 102, second BT device 106) transfer BT data back and forth using Profiles (e.g., BT Profiles 456), Services, and Characteristics during a low power mode. The AM GATT 452 may utilize AM ATT/EATT 454 to store Profiles, Services, Characteristics, and other BT context information related to the functions and operation of the LM/AM BT applications 462 and AM BT applications 464 during an active power mode of the system architecture 400. In other words, the AM GATT 452 may configure how BT data is transferred across the wireless connection based on the AM ATT/EATT 454.

The application processor 402 may include one or more drivers and/or interfaces to communicate BT data with the UART 432 of the BT controller 406. For example, the application processor 402 may include a kernel space that includes a multiple signal messages (MSM) UART driver 434 that is communicatively connected to the UART 432, and a teletypewriter (TTY)-driver 436 that is communicatively connected to the MSM UART driver 434. The AP BT stack 438 may include a BT-hardware abstraction layer (HAL) 440 that is configured to convey BT data with the TTY-driver and the AM HCl 442.

The low power processor 404 may include middleware 470 that communicates BT data from the LP BT stack 418 to the LM BT applications during a LM, and to an LM driver 472 during an active mode. The LM driver 472 may communicate BT data to the application processor 402 via a Glink 474. The Glink 474 may be in a Kernel space of the application processor 402 and may communicate BT data to a BTOffload HAL 475 in user space of the application processor 402. The BTOffload HAL 475 may relay the BT data to the BTOffload Service 476 and/or the BT Offload profile 456i.

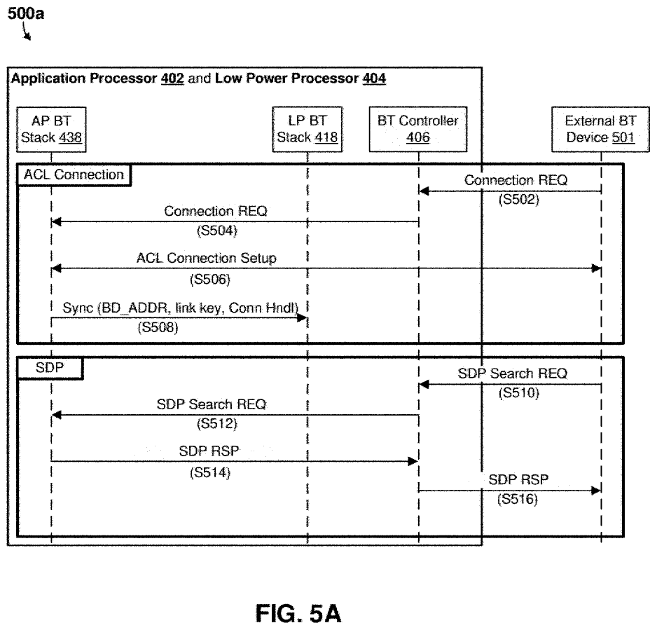

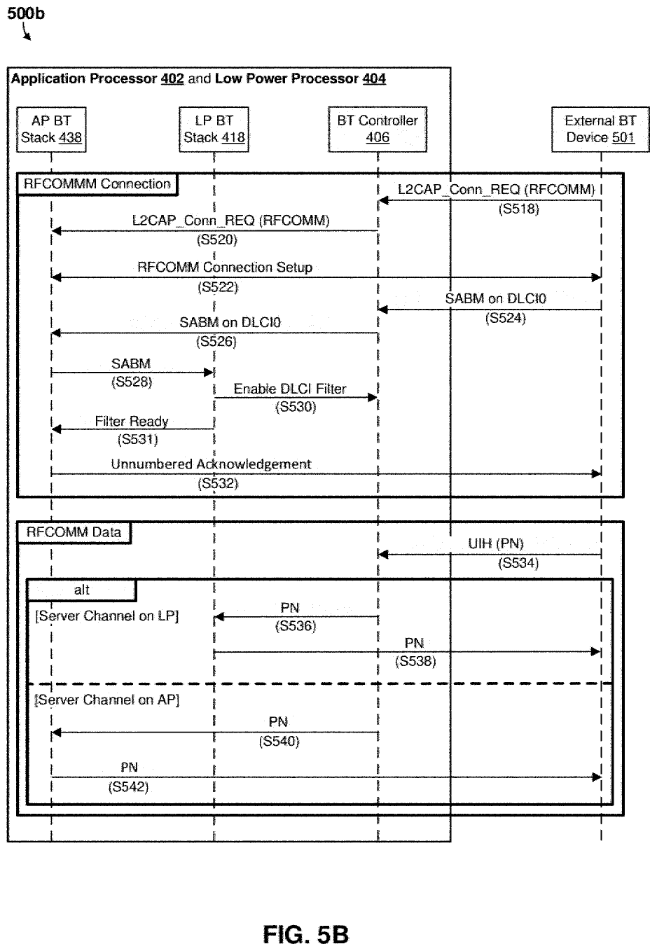

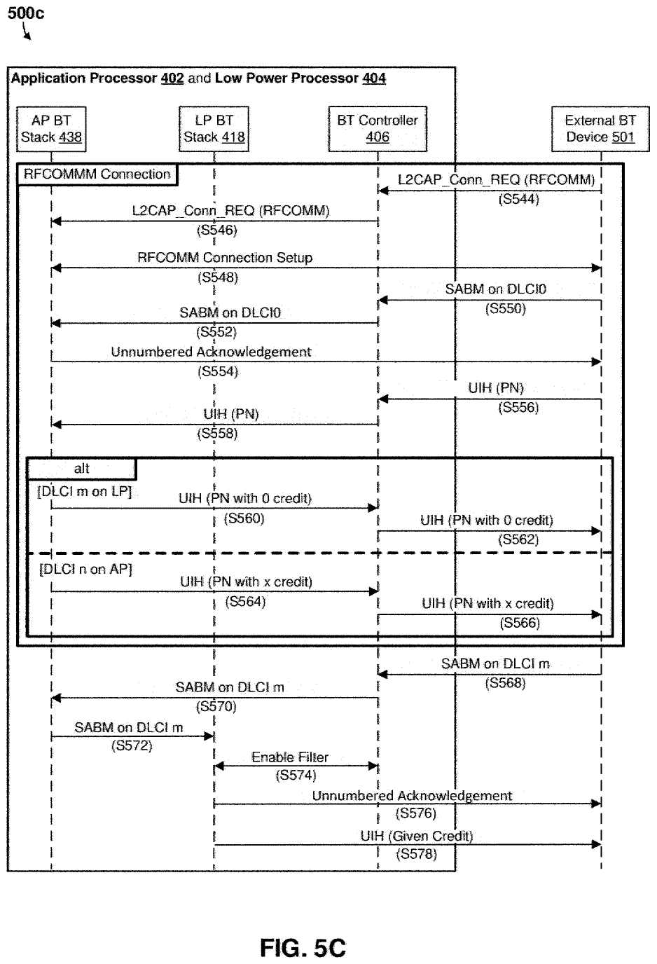

FIGS. 5A-5C are message flow diagrams 500a, 500b, and 500c illustrating various operations for managing an RFCOMM connection handover between two different BT stacks according to some embodiments. With reference to FIGS. 1-5C, an application processor 402 and a low power processor 404 is illustrated as being in communication with an external BT device 501 (e.g., second BT device 106 via the wireless connection 104). The application processor 402 and low power processor 404 may include a BT controller 406 that interfaces with the external BT device 501, an application processor (AP) BT stack 438 of the application processor 402, and a low power processor (LP) BT stack 418 of the low power processor 404. In some embodiments, the BT controller may be a component of the low power processor 404 and communicably connected to the AP BT stack 438 and the LP BT stack 418. In some embodiments, the application processor 402 and the low power processor 404 may be located within a single computing device, such as a SoC.

Referring to FIG. 5A, various operations S502-S516 are illustrated for establishing an ACL session (i.e., operations S502-S508) and performing SDP-related operations (i.e., operations S510-S516).

In operation S502, the BT controller 406 may receive an ACL connection request (REQ) message from the external BT device 501.

In operation S504, the BT controller 406 may transmit the ACL connection request message received from the external BT device 501 to the AP BT stack 438. By default, the AP BT stack 438 may manage and maintain ACL connections with any paired BT device.

In operation S506, the AP BT stack 438 may initialize ACL Connection Setup with the external BT device 501, and may maintain the ACL connection until termination of the ACL connection.

In operation S508, the AP BT stack 438 may transmit a synchronization message to the LP BT stack 418. In some embodiments, the synchronization message may include at least one of a BT device address (e.g., BD_ADDR), a link key, or a connection handle (e.g., Conn Hndl).

In operation S510, the BT controller 406 may receive an SDP search request from the external BT device 501. By querying SDP records, the external BT device 501 may determine any information necessary to connect to a service via RFCOMM.

In operation S512, the BT controller 406 may transmit the SDP search request received from the external BT device to the AP BT stack 438. The AP BT stack 438 may manage all SDP search requests received from paired BT devices.

In operation S514, the AP BT stack 438 may transmit an SDP response (RSP) message to the BT controller 406 in response to the SDP search request message previously received In operation S512. The SDP response message may include any information needed by the external BT device 501 for establishing an RFCOMM session with the computing device including the application processor 402 and the low power processor 404.

In operation S516, the BT controller 406 may transmit the SDP response message to the external BT device 501.

Following operation S516, the external device may transmit RFCOMM messages to the BT controller 406 for establishing and maintaining an RFCOMM connection. FIGS. 5B and 5C illustrate some embodiment message flow diagrams for managing RFCOMM connections and handling RFCOMM data between the AP BT stack 438 and the LP BT stack 418, the operations of which may be performed after executing operation S516 of FIG. 5A.

Referring to FIG. 5B, various operations S518-S542 are illustrated for establishing an RFCOMM connection (i.e., operations S518-S532) and communicating RFCOMM data across the established RFCOMM channel (i.e., operations S534-S542). The operations S518-S542 may be performed after operation S516 of FIG. 5A.

In operation S518, the BT controller 406 may receive an initialization message from the external BT device 501 for establishing an RFCOMM connection. The initialization message may be an L2CAP_Conn_REQ message.

In operation S520, the BT controller 406 may transmit the initialization message (e.g., L2CAP_Conn_Req) to the AP BT stack 438.

In operation S522, the AP BT stack 438 may perform an RFCOMM connection setup with the external BT device 501 in response to receiving the initialization message In operation S520.

In operation S524, the BT controller 406 may receive a Set Asynchronous Balanced Mode (SABM) command from the external BT device 501. The SABM command may be received on a Data Link Connection Identifier (DLCI) channel 0 (e.g., DLCI0). SABM is a “low-level” control frame. RFCOMM uses channels, each of which has a DLCI. Unnumbered Information with Header check (UIH) frames on DLCI0 (i.e., DLCI=0) may be used to send RFCOMM control messages (e.g., SABM command). UIH frames on DLCIs that are not DLCI0 may be used to send RFCOMM data.

In operation S526, the BT controller 406 may transmit the SABM command on DLCI0 to the AP BT stack 438. The AP BT stack 438 may read the SABM command from the DLCI0 channel or otherwise identify the SABM command from a sequence of control messages within the DLCI0 channel. The AP BT stack 438 may handle any and all additional messages received on the DLCI0 channel.

In operation 528, the AP BT stack 438 may transmit the SABM command to the LP BT stack 418.

In operation 530, the LP BT stack 418 may prepare or otherwise generate a filter policy based on the SABM command received from the AP BT stack 438, and may transmit a command message to the BT controller 406 to cause the BT controller 406 to enable a DLCI filter based on the generated filter policy.

In operation S531, the LP BT stack 418 may transmit a notification message to the AP BT stack 438 indicating that the filter policy created by the LP BT stack 418 have been enabled on the BT controller 406.

In operation S532, the AP BT stack 438 may transmit an Unnumbered Acknowledgement (UA) message to the external BT device 501 in response to receiving the notification message from the LP BT stack 418 In operation S531. The UA message may indicate that the BT controller 406 is ready to receive data from the external BT device 501, and the external BT device 501 may begin transmitting data to the BT controller 406. The UA message may be withheld until the AP BT stack 438 has been notified that the filter policy has been enabled on the BT controller 406.

In operation S534, the external BT device 501 may transmit data frames to the BT controller 406. For example, the BT controller 406 may receive UIH frames including one or more Parameter Negotiation (PN) commands from the external BT device 501.

The filter policy implemented by the BT controller 406 may enable the BT controller 406 to relay data to the appropriate BT stack, either the LP BT stack 418 or the AP BT stack 438. The BT controller 406 may be aware of where the server channel is being implemented (i.e., within the low power processor 404 or the application processor 402) based on the filter policy. For example, if the server channel is being implemented on the low power processor 404, the BT controller 406 may transmit the PN command(s) to the low power processor 404 In operation S536, and the low power processor 404 may transmit a PN response to the external BT device 501 In operation S538 in response to receiving the PN command from the BT controller 406. Alternatively, if the server channel is being implemented on the application processor 402, the BT controller 406 may transmit the PN command(s) to the application processor 402 In operation S540, and the application processor 402 may transmit a PN response to the external BT device 501 In operation S542 in response to receiving the PN command from the BT controller 406.

RFCOMM data may be continuously conveyed between the external BT device 501 and the LP BT stack 418 or the AP BT stack 438 based on the filter policy enabled within the BT controller 406. In some embodiments, the LP BT stack 418 may generate a new filter policy and may enable a new filter policy on the BT controller 406, overriding any existing filter policy.

Referring to FIG. 5C, various operations S544-S578 are illustrated for establishing an RFCOMM connection (i.e., operations S5544-S566) and enabling a filter based on SABM commands (i.e., operations S576-S578). The operations S544-S578 may be performed after operation S516 of FIG. 5A.

Operations S544-S552 may be performed in a similar manner as operations S518-S526 of FIG. 5B. For example, operations S544-S548 may be performed in a similar manner as operations S518-S522 to establish an RFCOMM connection between the AP BT stack 438 and the external BT device 501. The operations S550 and S552 may be performed in a similar manner as operations S524 and S526 to convey an SABM command on DLCI0 from the external BT device 501 to the AP BT stack 438.

In operation S554, the AP BT stack 438 may transmit a UA message to the external BT device 501. The UA message may indicate that the BT controller 406 is ready to receive data from the external BT device 501, and the external BT device 501 may begin transmitting data to the BT controller 406.

In operation S556, the external BT device 501 may transmit data frames to the BT controller 406. For example, the BT controller 406 may receive UIH frames including one or more PN commands from the external BT device 501.

In operation S558, the BT controller 406 may transmit the UIH frames including the PN commands to the AP BT stack 438. The AP BT stack 438 may manage all UIH data frames received from the external BT device 501.

The AP BT stack 438 may transmit a UIH response message to the external BT device 501 via the BT controller 406 in response to the UIH frames received In operation S558. The AP BT stack 438 may be aware of where each DLCI channel is being implemented (i.e., within the low power processor 404 or the application processor 402). For example, if a DLCI channel “m” is being implemented on the low power processor 404, the AP BT stack 438 may transmit a UIH response message including a PN command with 0 credit to the BT controller 406 In operation S560, and the BT controller 406 may transmit the UIH including PN command with 0 credit to the external BT device 501 In operation S562. The UIH including PN command with 0 credit may indicate to the external BT device 501 that the UIH frames are data frames from the DLCI m on the low power processor 404. Alternatively, if a DLCI channel “n” is being implemented on the application processor 402, the AP BT stack 438 may transmit a UIH response message including a PN command with “x” credit (i.e., nonzero credit) to the BT controller 406 In operation S564, and the BT controller 406 may transmit the UIH including PN command with “x” credit to the external BT device 501 In operation S566. The UIH including PN command with “x” credit may indicate to the external BT device 501 that the UIH frames are data frames from the DLCI n on the application processor 402.

In some embodiments, an SABM command for the DLCI implemented on the low power processor 404 may be received, and the operations S568-S578 may be performed.

In operation S568, the BT controller 406 may receive a SABM command from the external BT device 501. The SABM command may be received on a DLCI channel m (e.g., DLCI m).

In operation S570, the BT controller 406 may transmit the SABM command on DLCI m to the AP BT stack 438. The AP BT stack 438 may read the SABM command from the DLCI m channel or otherwise identify the SABM command from a sequence of control messages within the DLCI m channel. The AP BT stack 438 may handle any and all additional messages received on the DLCI m channel.

In operation 572, the AP BT stack 438 may transmit the SABM command to the LP BT stack 418.

In operation 574, the LP BT stack 418 may prepare or otherwise generate a filter policy based on the SABM command received from the AP BT stack 438, and may transmit a command message to the BT controller 406 to cause the BT controller 406 to enable a DLCI filter based on the generated filter policy.

In operation S576, the LP BT stack 418 may transmit a UA message to the external BT device 501. The UA message may indicate that the BT controller 406 is ready to receive data from the external BT device 501, and the external BT device 501 may begin transmitting data to the BT controller 406.

In operation S578, the LP BT stack 418 may transmit data frames to the external BT device 501. For example, the LP BT stack 418 may transmit UIH frames including Given Credit (i.e., nonzero credit) to the external BT device 501.

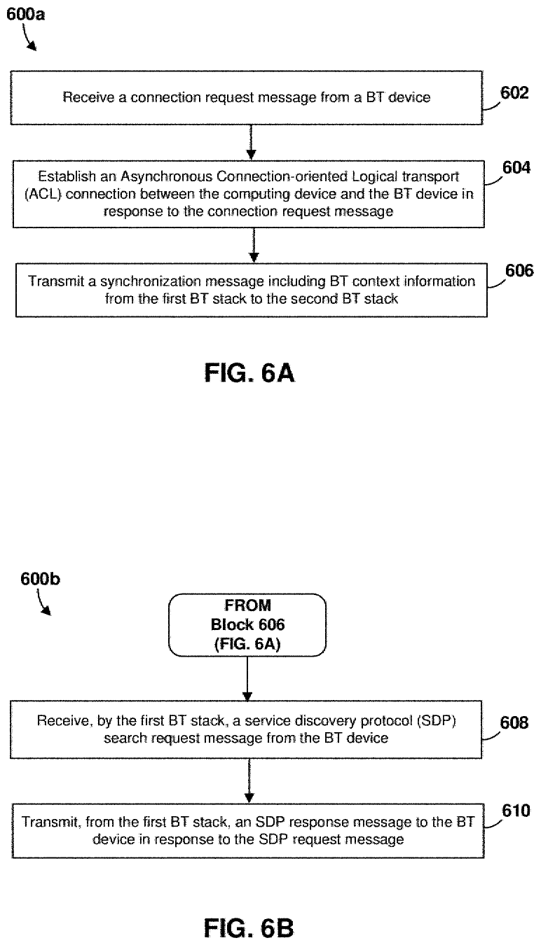

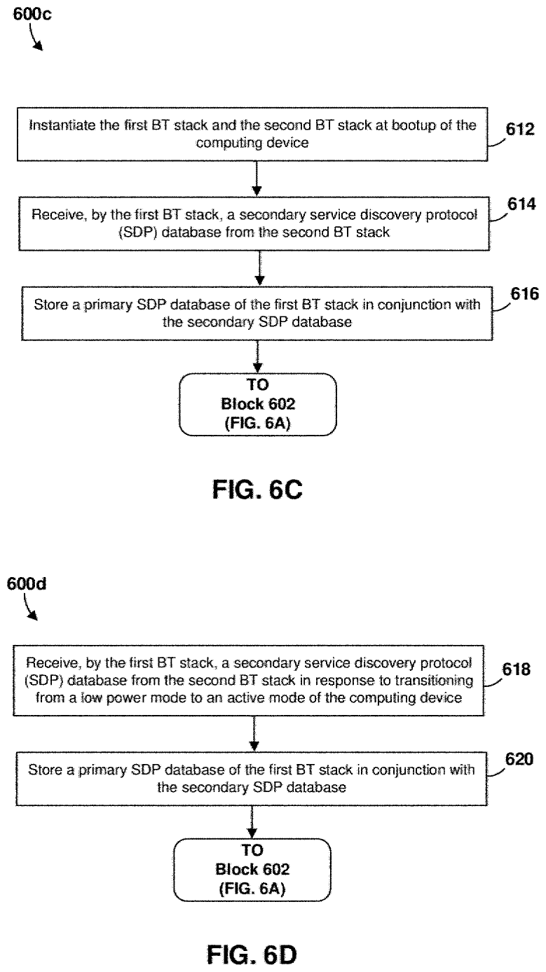

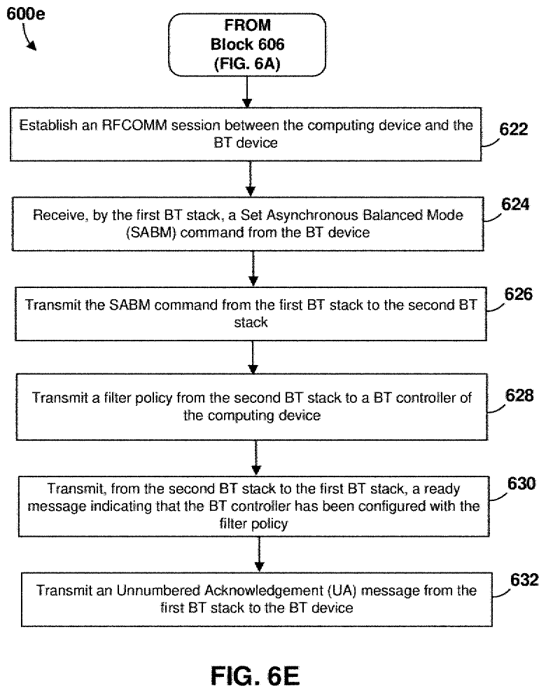

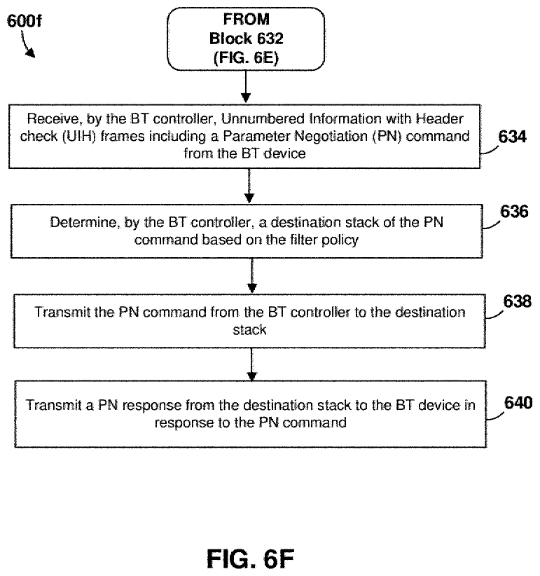

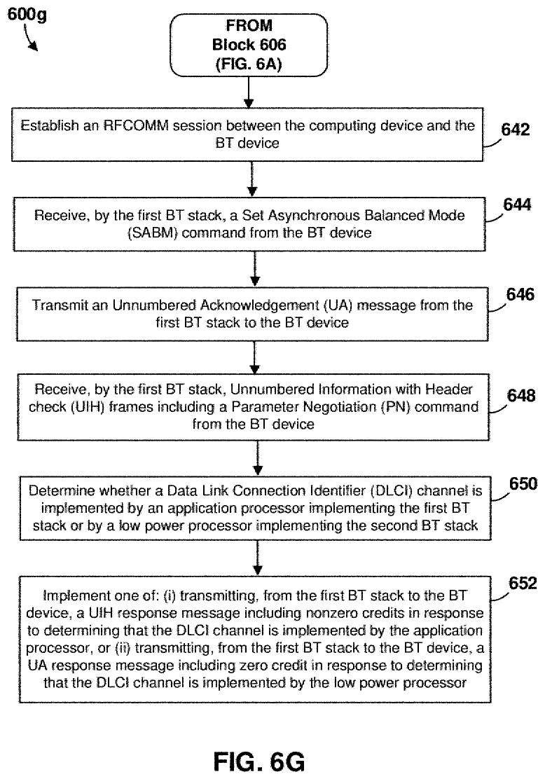

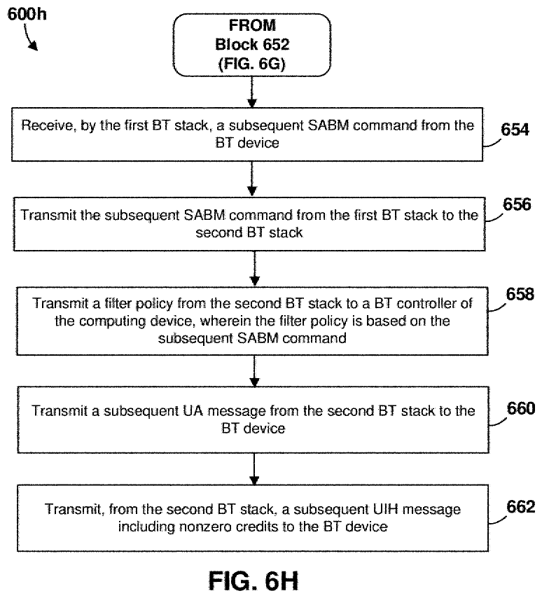

FIG. 6A is a process flow diagram of an example method 600a for managing RFCOMM connection handover between two different stacks in accordance with various embodiments. FIGS. 6B-6H are process flow diagrams of example operations 600b-600f that may be performed as part of the method 600a as described for managing RFCOMM connection handover between two different stacks in accordance with some embodiments. With reference to FIGS. 1-6H, the method 600a and the operations 600b-600h may be performed by a computing device (e.g., 102, 200, 302, 400). In some embodiments, the computing device may be configured to perform the operations by processor-executable instructions stored in a non-transitory processor-readable medium (e.g., 220, 258, 320). Means for performing each of the operations of the method 600a and the operations 600b-600h may be a processor of the systems 100, 200, 300, and 400 such as the processors 252, 322, 404, and/or the like as described with reference to FIGS. 1-6H.

In block 602, the computing device may perform operations including receiving a connection request message from a BT device (e.g., 106, 501). The computing device may receive a connection request message as described in operations S502 and S504. Means for performing the operations of block 602 may include a computing device (e.g., 102, 200, 302, 400) executing the transmit-receive module 330.

In block 604, the computing device may perform operations including establishing an ACL connection between the computing device and the BT device (e.g., 106, 501) in response to the connection request message. The computing device may receive a connection request message as described In operation S506. Means for performing the operations of block 604 may include a computing device (e.g., 102, 200, 302, 400) executing the ACL session module 332.

In block 606, the computing device may perform operations including transmitting a synchronization message including BT context information from the first BT stack (e.g., AP BT stack 438) to the second BT stack (e.g., LP BT stack 418). The computing device may transmit the synchronization message as described In operation S506. In some embodiments, the BT context information may include at least one of a BT device address (BD_ADDR), a link key, or a connection handle. Means for performing the operations of block 606 may include a computing device (e.g., 102, 200, 302, 400) executing the transmit-receive module 330.

FIG. 6B illustrates operations 600b that may be performed as part of the method 600a for managing RFCOMM connection handover between two different stacks in accordance with some embodiments. With reference to FIGS. 1-6B, following the operations in block 606, the computing device may perform operations including receiving, by the first BT stack (e.g., AP BT stack 438), an SDP search request message from the BT device (e.g., 106, 501) in block 608. The computing device may receive an SDP search request message as described in operations S510 and S512. Means for performing the operations of block 608 may include a computing device (e.g., 102, 200, 302, 400) executing the transmit-receive module 330.

In block 610, the computing device may perform operations including transmitting, from the first BT stack, an SDP response message to the BT device (e.g., 106, 501) in response to the SDP request message. The computing device may transmit an SDP response message as described in operations S514 and S516. Means for performing the operations of block 610 may include a computing device (e.g., 102, 200, 302, 400) executing the transmit-receive module 330.

FIG. 6C illustrates operations 600c that may be performed as part of the method 600a for managing RFCOMM connection handover between two different stacks in accordance with some embodiments.

In block 612, computing device may perform operations including instantiating the first BT stack (e.g., AP BT stack 438) and the second BT stack (e.g., LP BT stack 418) at bootup of the computing device. Means for performing the operations of block 612 may include a computing device (e.g., 102, 200, 302, 400) executing the stack management module 334.

In block 614, computing device may perform operations including receiving, by the first BT stack (e.g., AP BT stack 438), an SDP database from the second BT stack (LP BT stack 418). In some embodiments, by providing the AP BT stack 438 with the SDP database of the low power processor 404, the AP BT stack 438 may respond to any SDP request received from a BT device with full knowledge of both the SDP databases of the application processor 402 and the low power processor 404. Thus, the AP BT stack 438 may respond to SDP request messages with either application processor 402 SDP information or low power processor SDP information, depending on what processor is identified by the received SDP request. Means for performing the operations of block 614 may include a computing device (e.g., 102, 200, 302, 400) executing the transmit-receive module 330.

In block 616, computing device may perform operations including storing a primary SDP database of the first BT stack (e.g., AP BT stack 438) in conjunction with the secondary SDP database. Means for performing the operations of block 614 may include a computing device (e.g., 102, 200, 302, 400) executing the SDP database module 336.

Following the operations in block 616, the computing device may perform operations in block 602.

FIG. 6D illustrates operations 600d that may be performed as part of the method 600a for managing RFCOMM connection handover between two different stacks in accordance with some embodiments.

In block 618, computing device may perform operations including receiving, by the first BT stack (e.g., AP BT stack 438), an SDP database from the second BT stack (e.g., LP BT stack 418) in response to transitioning from a low power mode to an active mode of the computing device. In some embodiments, by providing the AP BT stack 438 with the SDP database of the low power processor 404, the AP BT stack 438 may respond to any SDP request received from a BT device with full knowledge of both the SDP databases of the application processor 402 and the low power processor 404. Thus, the AP BT stack 438 may respond to SDP request messages with either application processor 402 SDP information or low power processor SDP information, depending on what processor is identified by the received SDP request. Means for performing the operations of block 618 may include a computing device (e.g., 102, 200, 302, 400) executing the transmit-receive module 330.

In block 620, computing device may perform operations including storing a primary SDP database of the first BT stack (e.g., AP BT stack 438) in conjunction with the secondary SDP database. Means for performing the operations of block 620 may include a computing device (e.g., 102, 200, 302, 400) executing the SDP database module 336.

Following the operations in block 620, the computing device may perform operations in block 602.

FIG. 6E illustrates operations 600e that may be performed as part of the method 600a for managing RFCOMM connection handover between two different stacks in accordance with some embodiments. With reference to FIGS. 1-6E, following the operations in block 606, the computing device may perform operations including establishing an RFCOMM session between the computing device and the BT device (e.g., 106, 501) in block 622. The computing device may establish an RFCOMM session as described in operations S518-S522. Means for performing the operations of block 622 may include a computing device (e.g., 102, 200, 302, 400) executing the RFCOMM session module 338.

In block 624, the computing device may perform operations including receiving, by the first BT stack (e.g., AP BT stack 438), an SABM command from the BT device (e.g., 106, 501). The computing device may receive an SABM command as described in operations S524 and S526. Means for performing the operations of block 624 may include a computing device (e.g., 102, 200, 302, 400) executing the transmit-receive module 330.

In block 626, the computing device may perform operations including transmitting the SABM command from the first BT stack (e.g., AP BT stack 438) to the second BT stack (e.g., LP BT stack 418). The computing device may transmit the SABM command as described In operation S528. Means for performing the operations of block 626 may include a computing device (e.g., 102, 200, 302, 400) executing the transmit-receive module 330.

In block 628, the computing device may perform operations including transmitting a filter policy from the second BT stack (e.g., LP BT stack 418) to a BT controller 406 of the computing device, in which the filter policy is based on the SABM command. The computing device may transmit the filter policy as described In operation S530. Means for performing the operations of block 628 may include a computing device (e.g., 102, 200, 302, 400) executing the filter policy module 340 and the transmit-receive module 330.

In block 630, the computing device may perform operations including transmitting, from the second BT stack (e.g., LP BT stack 418) to the first BT stack (AP BT stack 438), a ready message indicating that the BT controller 406 has been configured with the filter policy. The filter policy may allow the BT controller 406 to route UIH messages including PN(s) to the appropriate BT stack. The computing device may transmit the ready message as described In operation S531. Means for performing the operations of block 630 may include a computing device (e.g., 102, 200, 302, 400) executing the transmit-receive module 330.

In block 632, the computing device may perform operations including transmitting a UA message from the first BT stack (e.g., AP BT stack 438) to the BT device (e.g., 106, 501). The computing device may transmit the UA as described In operation S532. Means for performing the operations of block 632 may include a computing device (e.g., 102, 200, 302, 400) executing the transmit-receive module 330.

FIG. 6F illustrates operations 600f that may be performed as part of the method 600a for managing RFCOMM connection handover between two different stacks in accordance with some embodiments. With reference to FIGS. 1-6F, following the operations in block 632, the computing device may perform operations including receiving, by the BT controller 406, UIH frames including a PN command from the BT device (e.g., 106, 501) in block 634. The computing device may receive the UIH frames as described In operation S534. Means for performing the operations of block 634 may include a computing device (e.g., 102, 200, 302, 400) executing the transmit-receive module 330.

In block 636, the computing device may perform operations including determining, by the BT controller 106, a destination stack of the PN command based on the filter policy, in which the destination stack is the first BT stack (e.g., AP BT stack 438) or the second BT stack (e.g., LP BT stack 418). Means for performing the operations of block 636 may include a computing device (e.g., 102, 200, 302, 400) executing the filter policy module 340.

In block 638, the computing device may perform operations including transmitting the PN command from the BT controller 106 to the destination stack (i.e., AP BT stack 438 or LP BT stack 418). The computing device may transmit the PN command as described In operation S536 or S540. Means for performing the operations of block 638 may include a computing device (e.g., 102, 200, 302, 400) executing the transmit-receive module 330.

In block 640, the computing device may perform operations including transmitting a PN response from the destination stack (e.g., AP BT stack 438 or LP BT stack 418) to the BT device (e.g., 106, 501) in response to the PN command. The computing device may transmit the PN as described in operations S538 or 542. Means for performing the operations of block 640 may include a computing device (e.g., 102, 200, 302, 400) executing the filter policy module 340 and the transmit-receive module 330.

FIG. 6G illustrates operations 600g that may be performed as part of the method 600a for managing RFCOMM connection handover between two different stacks in accordance with some embodiments. With reference to FIGS. 1-6G, following the operations in block 606, the computing device may perform operations including establishing an RFCOMM session between the computing device and the BT device (e.g., 106, 501) in block 642. The computing device may establish an RFCOMM session as described in operations S544-S548. Means for performing the operations of block 642 may include a computing device (e.g., 102, 200, 302, 400) executing the RFCOMM session module 338.

In block 644, the computing device may perform operations including receiving, by the first BT stack (e.g., AP BT stack 438), an SABM command from the BT device (e.g., 106, 501). The computing device may receive an SABM command as described in operations S550 and S552. Means for performing the operations of block 644 may include a computing device (e.g., 102, 200, 302, 400) executing the transmit-receive module 330.

In block 646, the computing device may perform operations including transmitting a UA message from the first BT stack (e.g., AP BT stack 438) to the BT device (e.g., 106, 501). The computing device may transmit the UA message as described In operation S554. Means for performing the operations of block 646 may include a computing device (e.g., 102, 200, 302, 400) executing the transmit-receive module 330.

In block 648, the computing device may perform operations including receiving, by the first BT stack (e.g., AP BT stack 438), UIH frames including a PN command from the BT device (e.g., 106, 501). The computing device may receive the UIH frames as described in operations S556 and S558. Means for performing the operations of block 648 may include a computing device (e.g., 102, 200, 302, 400) executing the transmit-receive module 330.

In block 650, the computing device may perform operations including determining whether a DLCI channel is implemented by an application processor 402 implementing the first BT stack (e.g., AP BT stack 438) or by a low power processor 404 implementing the second BT stack (e.g., LP BT stack 418). Means for performing the operations of block 650 may include a computing device (e.g., 102, 200, 302, 400) executing the stack management module 334.

In block 652, the computing device may perform operations including implementing one of (i) transmitting, from the first BT stack (e.g., AP BT stack 438) to the BT device (e.g., 106, 501), a UIH response message including nonzero credits in response to determining that the DLCI channel is implemented by the application processor 402, or (ii) transmitting, from the first BT stack to the BT device, a UA response message including zero credit in response to determining that the DLCI channel is implemented by the low power processor 404. The computing device may transmit the UIH response message as described In operation S531. Means for performing the operations of block 652 may include a computing device (e.g., 102, 200, 302, 400) executing the transmit-receive module 330.

FIG. 6H illustrates operations 600h that may be performed as part of the method 600a for managing RFCOMM connection handover between two different stacks in accordance with some embodiments. With reference to FIGS. 1-6H, following the operations in block 652, the computing device may perform operations including receiving, by the first BT stack (e.g., AP BT stack 438), a subsequent SABM command from the BT device (e.g., 106, 501) in block 654. The computing device may receive the subsequent SABM command as described in operations S568 and S570. Means for performing the operations of block 652 may include a computing device (e.g., 102, 200, 302, 400) executing the transmit-receive module 330.

In block 656, the computing device may perform operations including transmitting the subsequent SABM command from the first BT stack (e.g., AP BT stack 438) to the second BT stack (e.g., LP BT stack 418). The computing device may transmit the subsequent SABM command as described In operation S572. Means for performing the operations of block 656 may include a computing device (e.g., 102, 200, 302, 400) executing the filter policy module 340.

In block 658, the computing device may perform operations including transmitting a filter policy from the second BT stack (e.g., LP BT stack 418) to a BT controller 406 of the computing device, in which the filter policy is based on the subsequent SABM command. The computing device may transmit the PN command as described In operation S574. Means for performing the operations of block 658 may include a computing device (e.g., 102, 200, 302, 400) executing the filter policy module 340 and the transmit-receive module 330.

In block 660, the computing device may perform operations including transmitting a subsequent UA message from the second BT stack (e.g., LP BT stack 418) to the BT device (e.g., 106, 501). The computing device may transmit the subsequent UA message as described In operation S576. Means for performing the operations of block 660 may include a computing device (e.g., 102, 200, 302, 400) executing the transmit-receive module 330.

In block 662, the computing device may perform operations including transmitting, from the second BT stack (e.g., LP BT stack 418), a subsequent UIH message including nonzero credits to the BT device (e.g., 106, 501). The computing device may transmit the subsequent UIH message as described In operation S578. Means for performing the operations of block 662 may include a computing device (e.g., 102, 200, 302, 400) executing the transmit-receive module 330.

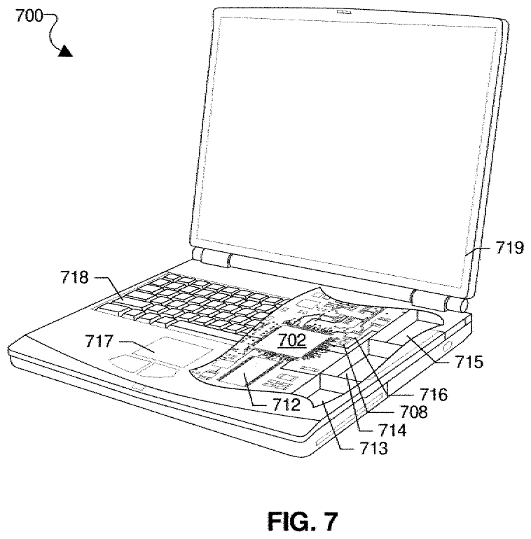

The various embodiments (including, but not limited to, embodiments described above with reference to FIGS. 1-5E) may be implemented in a wide variety of computing systems include a laptop computer 700 an example of which is illustrated in FIG. 7. With reference to FIGS. 1-7, a laptop computer may include a touchpad touch surface 717 that serves as the computer's pointing device, and thus may receive drag, scroll, and flick gestures similar to those implemented on computing devices equipped with a touch screen display and described above. A laptop computer 700 will typically include a processor 702 coupled to volatile memory 712 and a large capacity nonvolatile memory, such as a disk drive 713 of Flash memory. Additionally, the computer 700 may have one or more antenna 708 for sending and receiving electromagnetic radiation that may be connected to a wireless data link and/or cellular telephone transceiver 716 coupled to the processor 702. The computer 700 may also include a BT transceiver 714 and a compact disc (CD) drive 715 coupled to the processor 702. The laptop computer 700 may include a touchpad 717, a keyboard 718, and a display 719 all coupled to the processor 702. Other configurations of the computing device may include a computer mouse or trackball coupled to the processor (e.g., via a USB input) as are well known, which may also be used in conjunction with the various embodiments.

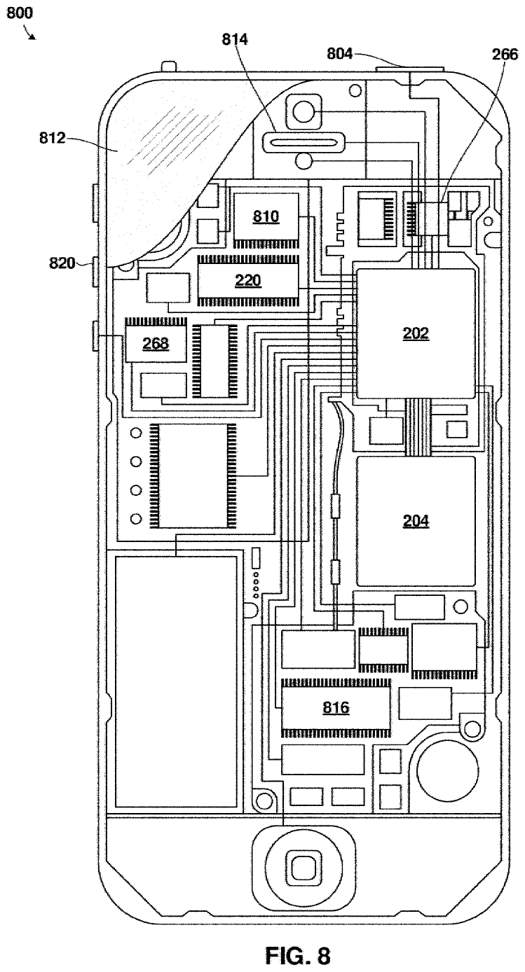

FIG. 8 is a component block diagram of a computing device 800 suitable for use with various embodiments. With reference to FIGS. 1-8, various embodiments may be implemented on a variety of computing devices 800 (e.g., 102, 200, 302, 400), an example of which is illustrated in FIG. 8 in the form of a smartphone. The computing device 800 may include a first SoC 202 (e.g., a SoC-CPU) coupled to a second SoC 204 (e.g., a 5G capable SoC). The first and second SoCs 202, 204 may be coupled to internal memory 816, a display 812, and to a speaker 814. The first and second SoCs 202, 204 may also be coupled to at least one SIM 268 and/or a SIM interface that may store information supporting a first 5GNR subscription and a second 5GNR subscription, which support service on a 5G non-standalone (NSA) network.

The computing device 800 may include an antenna 804 for sending and receiving electromagnetic radiation that may be connected to a wireless transceiver 266 coupled to one or more processors in the first and/or second SoCs 202, 204. The computing device 800 may also include menu selection buttons or rocker switches 820 for receiving user inputs.

The computing device 800 also includes a sound encoding/decoding (CODEC) circuit 810, which digitizes sound received from a microphone into data packets suitable for wireless transmission and decodes received sound data packets to generate analog signals that are provided to the speaker to generate sound. Also, one or more of the processors in the first and second SoCs 202, 204, wireless transceiver 266 and CODEC 810 may include a digital signal processor (DSP) circuit (not shown separately).

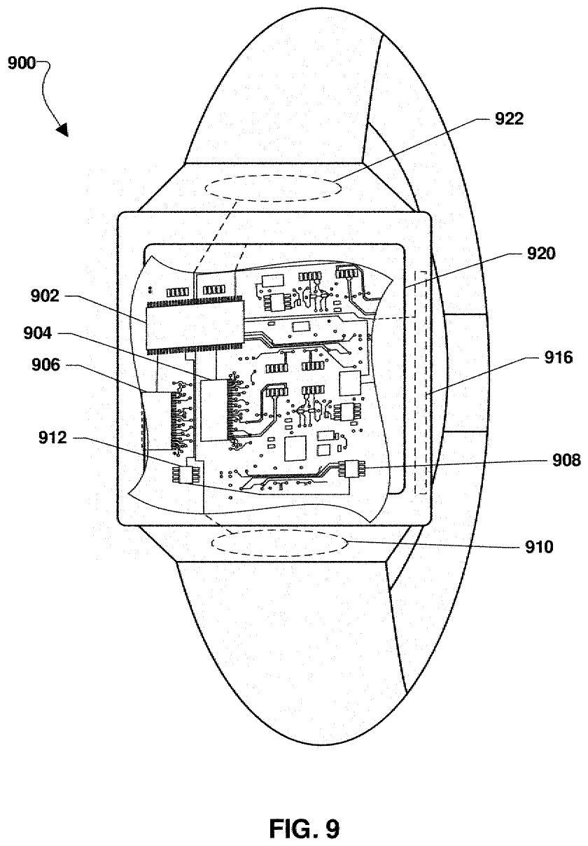

The various embodiments may be implemented within a variety of computing devices, such as a wearable computing device. FIG. 9 illustrates an example wearable computing device in the form of a smart watch 900 according to some embodiments. With reference to FIGS. 1-9, a smart watch 900 may include an SoC 902 including two or more processors (e.g., application processor, low power processor) coupled to internal memories 904 and 906. Internal memories 904, 906 may be volatile or non-volatile memories, and may also be secure and/or encrypted memories, or unsecure and/or unencrypted memories, or any combination thereof. The SoC 902 may also be coupled to a touchscreen display 920, such as a resistive-sensing touchscreen, capacitive-sensing touchscreen infrared sensing touchscreen, or the like. Additionally, the smart watch 900 may have one or more antenna 908 for sending and receiving electromagnetic radiation that may be connected to one or more wireless data links 912, such as one or more Bluetooth® transceivers, Peanut transceivers, Wi-Fi transceivers, ANT+ transceivers, etc., which may be coupled to the SoC 902. The smart watch 900 may also include physical virtual buttons 922 and 910 for receiving user inputs as well as a slide sensor 916 for receiving user inputs.

The touchscreen display 920 may be coupled to a touchscreen interface module that is configured receive signals from the touchscreen display 920 indicative of locations on the screen where a user's fingertip or a stylus is touching the surface and output to the SoC 902 information regarding the coordinates of touch events. Further, the SoC 902 may be configured with processor-executable instructions to correlate images presented on the touchscreen display 920 with the location of touch events received from the touchscreen interface module in order to detect when a user has interacted with a graphical interface icon, such as a virtual button.

The SoC 902 may be any programmable microprocessor, microcomputer or multiple processor chip or chips that can be configured by software instructions (applications) to perform a variety of functions, including the functions of the various embodiments. In some devices, multiple processors may be provided, such as one processor dedicated to wireless communication functions and one processor dedicated to running other applications. Typically, software applications may be stored in an internal memory before they are accessed and loaded into the SoC 902. The SoC 902 may include internal memory sufficient to store the application software instructions. In many devices the internal memory may be a volatile or nonvolatile memory, such as flash memory, or a mixture of both. For the purposes of this description, a general reference to memory refers to memory accessible by the SoC 902 including internal memory or removable memory plugged into the mobile device and memory within the SoC 902 itself.

The processors of the computer 700, the computing device 800, and the smart watch 900 may be any programmable microprocessor, microcomputer, or multiple processor chip or chips that can be configured by software instructions (applications) to perform a variety of functions, including the functions of the various embodiments described. In some mobile devices, multiple processors may be provided, such as one processor within an SoC 204 dedicated to wireless communication functions and one processor within an SoC 202 dedicated to running other applications. Software applications may be stored in the memory 220, 258, 320, 816 before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a computing device for managing a radio frequency communication (RFCOMM) connection handover between a first Bluetooth (BT) stack and a second BT stack, including: receiving a connection request message from a BT device; establishing an Asynchronous Connection-oriented Logical transport (ACL) connection between the computing device and the BT device in response to the connection request message; and transmitting a synchronization message including BT context information from the first BT stack to the second BT stack.

Example 2. The method of method 1, in which the BT context information includes at least one of a BT device address (BD_ADDR), a link key, or a connection handle.

Example 3. The method of either of method 1 or method 2, further including: receiving, by the first BT stack, a service discovery protocol (SDP) search request message from the BT device; and transmitting, from the first BT stack, an SDP response message to the BT device in response to the SDP request message.

Example 4. The method of any of methods 1-3, further including: instantiating the first BT stack and the second BT stack at bootup of the computing device; receiving, by the first BT stack, a secondary service discovery protocol (SDP) database from the second BT stack; and storing a primary SDP database of the first BT stack in conjunction with the secondary SDP database.

Example 5. The method of any of methods 1-4, further including: receiving, by the first BT stack, a secondary service discovery protocol (SDP) database from the second BT stack in response to transitioning from a low power mode to an active mode of the computing device; and storing a primary SDP database of the first BT stack in conjunction with the secondary SDP database.

Example 6. The method of any of methods 1-5, further including: establishing an RFCOMM session between the computing device and the BT device; receiving, by the first BT stack, a Set Asynchronous Balanced Mode (SABM) command from the BT device; transmitting the SABM command from the first BT stack to the second BT stack; transmitting a filter policy from the second BT stack to a BT controller of the computing device, in which the filter policy is based on the SABM command; transmitting, from the second BT stack to the first BT stack, a ready message indicating that the BT controller has been configured with the filter policy; and transmitting an Unnumbered Acknowledgement (UA) message from the first BT stack to the BT device.

Example 7. The method of method 6, further including: receiving, by the BT controller, Unnumbered Information with Header check (UIH) frames including a Parameter Negotiation (PN) command from the BT device; determining, by the BT controller, a destination stack of the PN command based on the filter policy, in which the destination stack is the first BT stack or the second BT stack; transmitting the PN command from the BT controller to the destination stack; and transmitting a PN response from the destination stack to the BT device in response to the PN command.

Example 8. The method of method 1, further including: establishing an RFCOMM session between the computing device and the BT device; receiving, by the first BT stack, a Set Asynchronous Balanced Mode (SABM) command from the BT device; transmitting an Unnumbered Acknowledgement (UA) message from the first BT stack to the BT device; receiving, by the first BT stack, Unnumbered Information with Header check (UIH) frames including a Parameter Negotiation (PN) command from the BT device; determining whether a Data Link Connection Identifier (DLCI) channel is implemented by an application processor implementing the first BT stack or by a low power processor implementing the second BT stack; and implementing one of: transmitting, from the first BT stack to the BT device, a UIH response message including nonzero credits in response to determining that the DLCI channel is implemented by the application processor; or transmitting, from the first BT stack to the BT device, a UA response message including zero credit in response to determining that the DLCI channel is implemented by the low power processor.

Example 9. The method of method 8, further including: receiving, by the first BT stack, a subsequent SABM command from the BT device; transmitting the subsequent SABM command from the first BT stack to the second BT stack; transmitting a filter policy from the second BT stack to a BT controller of the computing device, in which the filter policy is based on the subsequent SABM command; transmitting a subsequent UA message from the second BT stack to the BT device; and transmitting, from the second BT stack, a subsequent UIH message including nonzero credits to the BT device.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), Long Term Evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general Packet Radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method performed by a computing device for managing a radio frequency communication (RFCOMM) connection handover between a first Bluetooth (BT) stack and a second BT stack, comprising:
receiving a connection request message from a BT device;
establishing an Asynchronous Connection-oriented Logical transport (ACL) connection between the computing device and the BT device in response to the connection request message; and
transmitting a synchronization message including BT context information from the first BT stack to the second BT stack.

2. The method of claim 1, wherein the BT context information includes at least one of a BT device address (BD_ADDR), a link key, or a connection handle.

3. The method of claim 1, further comprising:
receiving, by the first BT stack, a service discovery protocol (SDP) search request message from the BT device; and
transmitting, from the first BT stack, an SDP response message to the BT device in response to the SDP request message.

4. The method of claim 1, further comprising:
instantiating the first BT stack and the second BT stack at bootup of the computing device;
receiving, by the first BT stack, a secondary service discovery protocol (SDP) database from the second BT stack; and
storing a primary SDP database of the first BT stack in conjunction with the secondary SDP database.

5. The method of claim 1, further comprising:
receiving, by the first BT stack, a secondary service discovery protocol (SDP) database from the second BT stack in response to transitioning from a low power mode to an active mode of the computing device; and
storing a primary SDP database of the first BT stack in conjunction with the secondary SDP database.

6. The method of claim 1, further comprising:
establishing an RFCOMM session between the computing device and the BT device;
receiving, by the first BT stack, a Set Asynchronous Balanced Mode (SABM) command from the BT device;
transmitting the SABM command from the first BT stack to the second BT stack;
transmitting a filter policy from the second BT stack to a BT controller of the computing device, wherein the filter policy is based on the SABM command;
transmitting, from the second BT stack to the first BT stack, a ready message indicating that the BT controller has been configured with the filter policy; and
transmitting an Unnumbered Acknowledgement (UA) message from the first BT stack to the BT device.

7. The method of claim 6, further comprising:
receiving, by the BT controller, Unnumbered Information with Header check (UIH) frames including a Parameter Negotiation (PN) command from the BT device;
determining, by the BT controller, a destination stack of the PN command based on the filter policy, wherein the destination stack is the first BT stack or the second BT stack;
transmitting the PN command from the BT controller to the destination stack; and
transmitting a PN response from the destination stack to the BT device in response to the PN command.

8. The method of claim 1, further comprising:
establishing an RFCOMM session between the computing device and the BT device;
receiving, by the first BT stack, a Set Asynchronous Balanced Mode (SABM) command from the BT device;
transmitting an Unnumbered Acknowledgement (UA) message from the first BT stack to the BT device;
receiving, by the first BT stack, Unnumbered Information with Header check (UIH) frames including a Parameter Negotiation (PN) command from the BT device;
determining whether a Data Link Connection Identifier (DLCI) channel is implemented by an application processor implementing the first BT stack or by a low power processor implementing the second BT stack; and
implementing one of:
transmitting, from the first BT stack to the BT device, a UIH response message including nonzero credits in response to determining that the DLCI channel is implemented by the application processor; or
transmitting, from the first BT stack to the BT device, a UA response message including zero credit in response to determining that the DLCI channel is implemented by the low power processor.

9. The method of claim 8, further comprising:
receiving, by the first BT stack, a subsequent SABM command from the BT device;
transmitting the subsequent SABM command from the first BT stack to the second BT stack;
transmitting a filter policy from the second BT stack to a BT controller of the computing device, wherein the filter policy is based on the subsequent SABM command;
transmitting a subsequent UA message from the second BT stack to the BT device; and
transmitting, from the second BT stack, a subsequent UIH message including nonzero credits to the BT device.

10. A computing device, comprising:
a Bluetooth (BT) device;
an application processor coupled to the BT device and comprising a first Bluetooth (BT) stack; and
a low power processor coupled to the BT device and the application processor and comprising a second BT stack,
wherein the computing device is configured to:
receive a connection request message from the BT device;
establish an Asynchronous Connection-oriented Logical transport (ACL) connection between the computing device and the BT device in response to the connection request message; and
transmit a synchronization message including BT context information from the first BT stack to the second BT stack as part of a radio frequency communication (RFCOMM) connection handover between the first Bluetooth (BT) stack and the second BT stack.

11. The computing device of claim 10, wherein the BT context information includes
at least one of a BT device address (BD ADDR), a link key, or a connection handle.

12. The computing device of claim 10, wherein the computing device is further configured to:
receive, by the first BT stack, a service discovery protocol (SDP) search request message from the BT device; and
transmit, from the first BT stack, an SDP response message to the BT device in response to the SDP request message.

13. The computing device of claim 10, wherein the computing device is further configured to:
instantiate the first BT stack and the second BT stack at bootup of the computing device;
receive, by the first BT stack, a secondary service discovery protocol (SDP) database from the second BT stack; and
store a primary SDP database of the first BT stack in conjunction with the secondary SDP database.

14. The computing device of claim 10, wherein the computing device is further configured to:
receive, by the first BT stack, a secondary service discovery protocol (SDP) database from the second BT stack in response to transitioning from a low power mode to an active mode of the computing device; and
store a primary SDP database of the first BT stack in conjunction with the secondary SDP database.

15. The computing device of claim 10, wherein the computing device is further configured to:
establishing an RFCOMM session between the computing device and the BT device;
receiving, by the first BT stack, a Set Asynchronous Balanced Mode (SABM) command from the BT device;
transmit the SABM command from the first BT stack to the second BT stack;
transmit a filter policy from the second BT stack to a BT controller of the computing device, wherein the filter policy is based on the SABM command;
transmit, from the second BT stack to the first BT stack, a ready message indicating that the BT controller has been configured with the filter policy; and
transmit an Unnumbered Acknowledgement (UA) message from the first BT stack to the BT device.

16. The computing device of claim 15, wherein the computing device is further configured to:
receive, by the BT controller, Unnumbered Information with Header check (UIH) frames including a Parameter Negotiation (PN) command from the BT device;
determine, by the BT controller, a destination stack of the PN command based on the filter policy, wherein the destination stack is the first BT stack or the second BT stack;
transmit the PN command from the BT controller to the destination stack; and
transmit a PN response from the destination stack to the BT device in response to the PN command.

17. The computing device of claim 10, wherein the computing device is further configured to:
establish an RFCOMM session between the computing device and the BT device;
receive, by the first BT stack, a Set Asynchronous Balanced Mode (SABM) command from the BT device;
transmit an Unnumbered Acknowledgement (UA) message from the first BT stack to the BT device;
receive, by the first BT stack, Unnumbered Information with Header check (UIH) frames including a Parameter Negotiation (PN) command from the BT device;
determine whether a Data Link Connection Identifier (DLCI) channel is implemented by the application processor implementing the first BT stack or by the low power processor implementing the second BT stack; and either:
transmit, from the first BT stack to the BT device, a UIH response message including nonzero credits in response to determining that the DLCI channel is implemented by the application processor; or
transmit, from the first BT stack to the BT device, a UA response message including zero credit in response to determining that the DLCI channel is implemented by the low power processor.

18. The computing device of claim 17, wherein the computing device is further configured to:
receive, by the first BT stack, a subsequent SABM command from the BT device;
transmit the subsequent SABM command from the first BT stack to the second BT stack;
transmit a filter policy from the second BT stack to a BT controller of the computing device, wherein the filter policy is based on the subsequent SABM command;
transmit a subsequent UA message from the second BT stack to the BT device; and
transmit, from the second BT stack, a subsequent UIH message including nonzero credits to the BT device.

19. A computing device, comprising:
a Bluetooth (BT) device;
an application processor coupled to the BT device and comprising a first Bluetooth (BT) stack;
a low power processor coupled to the BT device and the application processor and comprising a second BT stack;
means for receiving a connection request message from the BT device; means for establishing an Asynchronous Connection-oriented Logical transport (ACL) connection between the computing device and the BT device in response to the connection request message; and
means for transmitting a synchronization message including BT context information from the first BT stack to the second BT stack as part of a radio frequency communication (RFCOMM) connection handover between the first Bluetooth (BT) stack and the second BT stack.

20-23. (canceled)

24. The computing device of claim 19, further comprising:
means for establishing an RFCOMM session between the computing device and the BT device;
means for receiving, by the first BT stack, a Set Asynchronous Balanced Mode (SABM) command from the BT device;
means for transmitting the SABM command from the first BT stack to the second BT stack;
means for transmitting a filter policy from the second BT stack to a BT controller of the computing device, wherein the filter policy is based on the SABM command;
means for transmitting, from the second BT stack to the first BT stack, a ready message indicating that the BT controller has been configured with the filter policy; and
means for transmitting an Unnumbered Acknowledgement (UA) message from the first BT stack to the BT device.

25-30. (canceled)
